(19) United States
(12) Patent Application Publication
(10) Pub. No.: US 2007/0136995 A1
(43) Pub. Date: Jun. 21, 2007

(54) HINGE ASSEMBLY FOR FLAT DISPLAY MONITOR

(75) Inventors: An-Kui Hu, Shenzhen (CN); Yan-Qun Wen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,518

(22) Filed: Aug. 16, 2006

(30) Foreign Application Priority Data
Dec. 1, 2005 (CN) 200510102120.3

(51) Int. Cl. E05D 11/08

(52) U.S. Cl. 16/340

(57) ABSTRACT

A hinge assembly (300) for use in a flat display monitor includes a base seat (10), a support seat (20) and a pivotal mechanism. The pivotal mechanism comprises a pivotal shaft (30) having at least one flat surface (310). The base seat defines a pivotal hole (142) therein. The support seat defines an engaging hole (242). The base seat is rotatable relative to the support seat. The pivotal shaft passes through the pivotal hole of the base seat and the engaging hole of the support seat. One of the base seat and the support seat defines a protrusion (143). The protrusion is substantially V-shaped and has two edges (1432, 1434). The flat surface of the pivotal shaft pivotally engages with the protrusion. Another one of the pivotal hole of the base seat and the engaging hole of the support seat non-rotatably engages with the pivotal shaft.

### 1. FIELD OF THE INVENTION

The present invention generally relates to hinge assemblies and, particularly, to a hinge assembly for a flat display monitor.

### 2. DISCUSSION OF THE RELATED ART

With the widespread use and the variety of computers available, display device, configured for such a variety of computers also come in a variety of sizes, shapes, and weight. In general, a typical cathode-ray tube (CRT) monitor includes a display panel for displaying an image, a vacuum tube coupled to the rear of the display panel, and an electron gun coupled to the rear of the vacuum tube. This configuration is a huge factor in limiting the total volume and final weight of the CRT monitor. In addition, the CRT monitor carries a huge problem in that a user is easily fatigued when looking at the CRT monitor over long hours due to its low image quality. It is this problem alone that many people switched to using a flat screen display monitor, e.g., liquid crystal display (LCD) monitor, from the conventional CRT monitors. Such flat display monitors generally offer the advantages of a greatly reduced size and weight properties including the ability to produce a high image quality. Furthermore, flat screen display monitors may help to overcome space limitations through folding over (such as with a laptop computer) or rotating (such as with a desktop monitor) so as to facilitate adjustment of the position thereof relative to the user.

The rotating or folding-over functions of the flat display monitor are realized with a hinge assembly. A hinge assembly includes an L-shaped fixed seat, a pivotal axle, and a number of oiled washers. The fixed seat has a retaining hole defined therein. The pivotal axle is pivotally connected with the fixed seat. The pivotal axle has a retaining shoulder formed at a middle portion thereof, a connecting end portion integrally formed at a first end of the retaining shoulder, and a fixing end portion integrally formed at a second end of the retaining shoulder. The connecting end portion of the pivotal axle extends through a retaining hole of the fixed seat along with the oiled washers, and then fastened by a fastening piece. However, in use, it needs to use great efforts to rotate the hinge assembly, since a greater force is exerted thereon. As a result, it is inconvenient for a user to operate the hinge assembly.

Therefore, a new hinge assembly is desired in order to overcome the above-described shortcomings.

### SUMMARY

In one embodiment thereof, a hinge assembly for use in a flat display monitor includes a base seat, a support seat and a pivotal mechanism. The pivotal mechanism comprises a pivotal shaft having at least one flat surface. The base seat defines a pivotal hole therein. The support seat defines an engaging hole. The base seat is rotatable relative to the support seat. The pivotal shaft passes through the pivotal hole of the base seat and the engaging hole of the support seat. One of the base seat and the support seat defines a protrusion. The protrusion is substantially V-shaped and has two edges. The flat surface of the pivotal shaft pivotally engages with the protrusion. Another one of the pivotal hole of the base seat and the engaging hole of the support seat non-rotatably engages with the pivotal shaft.

Other advantages and novel features will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the hinge assembly. Moreover, in the drawings, like reference numerals designate corresponding parts throughout the several views.

FIG. 1 is an isometric view of one embodiment of a hinge assembly, as used in a flat display screen;

FIG. 2 is an exploded, isometric view of the hinge assembly shown in FIG. 1;

FIG. 3 is an assembled, isometric view of the hinge assembly in FIG. 2;

FIG. 4 is a cut-away view taken along line IV-IV in FIG. 3; and

FIG. 5 is a cut-away view taken along line V-V in FIG. 3.

### DETAILED DESCRIPTION OF THE EMBODIMENTS

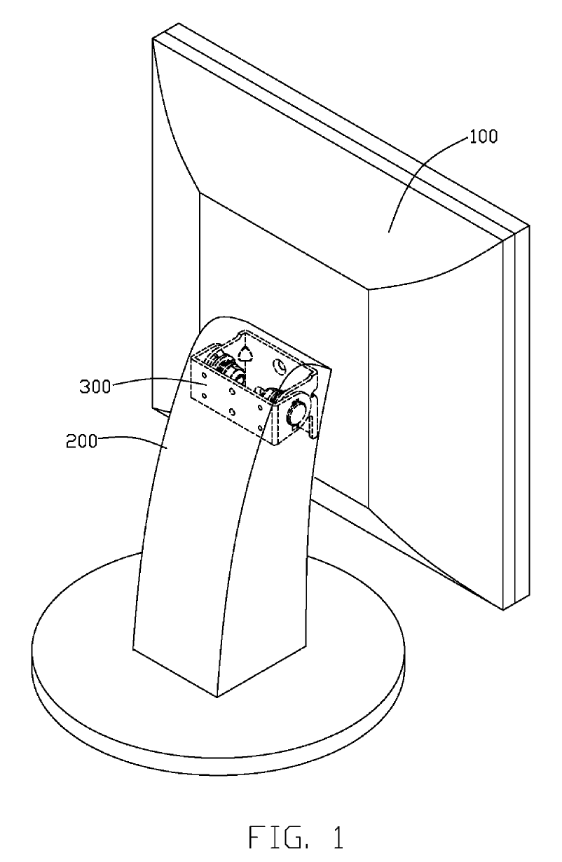

Referring to drawings in detail, FIG. 1 shows a flat display monitor employing a hinge assembly 300 in accordance with one embodiment of the present application. The flat display monitor is taken here as an exemplary application, for the purposes of describing details of the hinge assembly 300. It is to be understood, however, that the hinge assembly 300 could be advantageously used in other environments (e.g. cabinet doors). As such, although providing particularly advantages when used in flat display monitors, the hinge assembly 300 should not be considered limited in scope solely to an intended use environment of flat display monitors. A hinge assembly 300 is illustrated in the flat display monitor as shown in FIG. 1. The flat display monitor includes a display unit 100 and a support body 200. The hinge assembly 300 connects the display unit 100 to the support body 200 so that the display unit 100 can be pivoted relative to the support body 200.

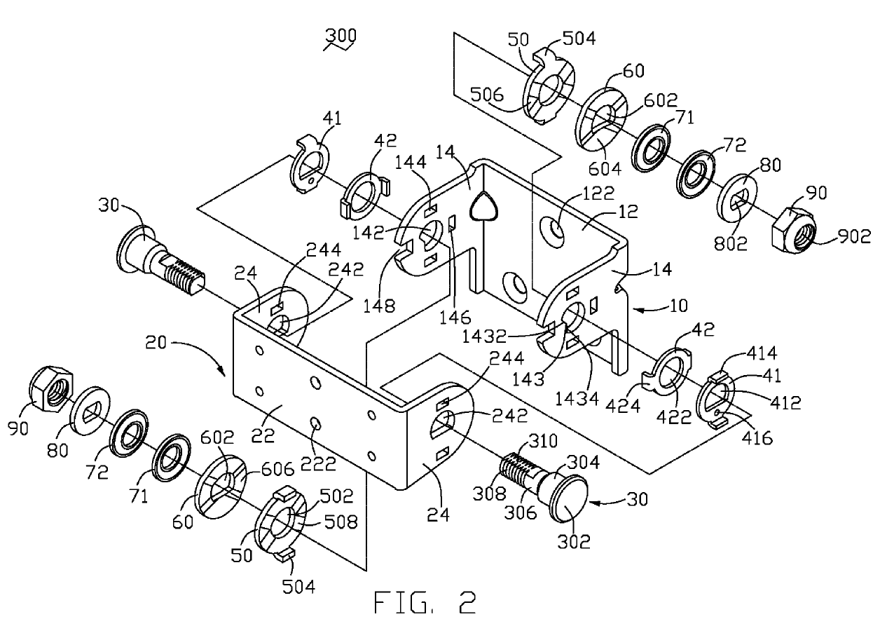

Referring to FIG. 2, the hinge assembly 300 includes a base seat 10, a support seat 20, two pivot mechanisms (not labeled) each including a pivotal shaft 30, a first tab washer 41, a second tab washer 42, a first irregular washer 50, a second irregular washer 60, a pair of spring/cupped springs washers 71 and 72, a flat washer 80, and a nut 90. The hinge assembly 300 uses the base seat 10 and the support seat 20 to connect to the display unit 100 and the support body 200 respectively. The pivotal shaft 30 passes through the support seat 20, the base seat 10, and the multiple washers 41, 42, 50, 60, 71, 72, and 80. The pivotal shaft 30 is then fastened in its assembled position with the nut 90.

The base seat 10 is substantially a board, which includes a main board 12. The main board 12 has several mounting holes 122 defined therein. The base seat 10 may be fixed on the display unit 100 by means of the mounting holes 122. The main board 12 perpendicularly disposes two symmetrical pivot flanges 14 at two ends thereof. Each pivot flange 14 is perpendicular to the main board 1 2. Each pivot flange 14 is substantially half-circular in shape, and has a pivotal hole 142 defined therein. A protrusion 143 extends inwards on an arc of the pivotal hole 142. The protrusion 143 has two symmetrical edges 1432 and 1434 and is substantially □-shaped (i.e., a rotated wide-angled V shape). An angle defined by the edges 1432 and 1434 establishes the rotational angle limits for the two pivot sets of hinge assembly 300 and, thus, for the display unit 100 relative to the support body 200. Each pivot flange 14 defines two locking slots 144, a locking hole 146, and a locking groove 148 adjacent to each side of the pivotal hole 142. The locking groove 148 is defined in a periphery of the pivot flange 14 and is opposite to the main board 12. The locking hole 146 is defined opposite to the locking groove 148. The locking slots 144 are adjacent each other facing opposite directions. One such protrusion 143 is readily manufactured. A precision of rotation range is easily controlled.

The base seat 20 includes a fixing board 22 and two sideboards 24. The fixing board 22 defines a plurality of assembling holes 222. The base seat 20 is mounted to the support body 200 by means of the assembling holes 222. Two opposite edges of the sideboard each forms a sideboard 24 perpendicularly extending outward. Each of the sideboards 24 defines an engaging hole 242 and two opposite fixing holes 244. The engaging holes 242 are deformed, i.e., are non-circular holes. In this embodiment, the engaging holes 242 are “D” shaped.

The pivotal shaft 30 includes a bolt cap 302, a middle portion 304 and a bolt shaft 306. The bolt cap 302 is substantially a disk-like shape. The middle portion 304 is cylinder-shaped. The bolt shaft 306 defines a thread 308 on a distal end portion thereof opposite to the bolt cap 302. The bolt shaft 306 defines two opposite flat surfaces 310 along a line parallel to an axis thereof. Thereby, the thread 308 thereof is non-continuous and a section of this portion of the bolt shaft 306 is approximately oval-shaped. The bolt shaft 306 may pass through the engaging hole 242 of the base seat 20 and the pivotal hole 142 of the support seat 10.

The first and second tab washers 41 and 42 are approximately ring-shaped. The first tab washer 41 defines a “D” shaped deformed hole 412 in the center. Two opposite tabs 414 are formed at a periphery of the first tab washer 41. The first tab washer 41 further defines an oil hole 41 6 for receiving lubricant. The second tab washer 42 defines a through hole 422 in the center and forms two opposite tabs 424 at a periphery thereof. The tabs 424 of the second tab washer 42 are configured to engage in the locking hole 146 and the locking groove 148 of the base seat 10. The tabs 414 of the first tab washer 41 are configured to engage in the fixing holes 244 of the support seat 20.

The first and second irregular washers 50 and 60 are approximately ring-shaped. The first irregular washer 50 defines a center hole 502 and forms two opposite inserting tabs 504 at a periphery thereof for engaging in the locking slots 144 of the base seat 10. The first irregular washer 50 has two opposite side surfaces 506 and 508 which are unsmooth. The second irregular washer 60 defines a “D” shaped latching hole 602. The second irregular washer 60 has two opposite side surfaces 604 and 606 which are unsmooth, i.e., having protrusive portions and depressive portions. Each two first and second irregular washers 50 and 60 are disposed next to each other with the side surfaces 506 and 606 abut against each other.

The spring washers 71 and 72 are plate-shaped. Two spring washers 71 and 72 are disposed adjacent each other facing opposite directions. The spring washers 71 and 72 are configured to provide an axial force. An amount of friction that helps the display unit 100 retaining any desired positions relative to the support body 200 is generated between the elements of the pivot mechanisms. Thus, the display unit 100 can retain any position relative to the support body 200.

The flat washer 80 is ring-shaped. The flat washer 80 defines an irregular hole 802 in the center for engaging with the bolt shaft 306 of the pivotal shaft 30. The nut 90 defines a thread 902 therein for engaging with the thread 308 of the bolt shaft 306 of the pivotal shaft 30.

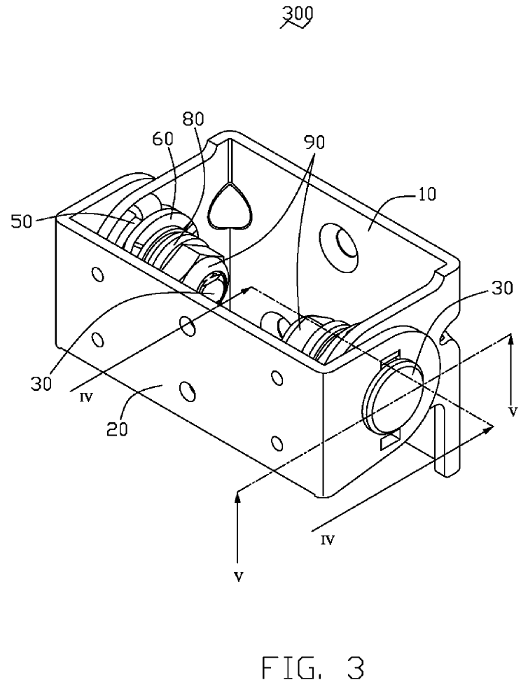

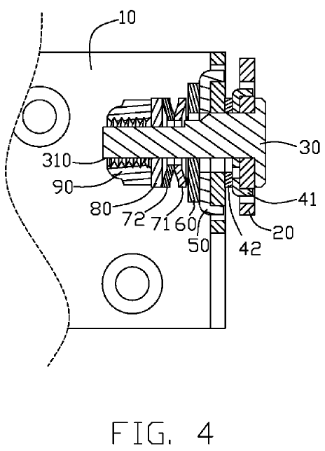

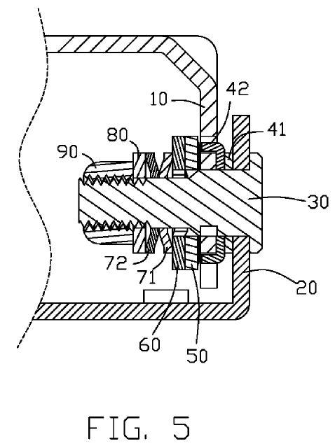

During assembly, referring now to FIGS. 3-5, with the tabs 414 engaging in the fixing hole 244 of the support seat 20, one first tab washer 41 is fixedly disposed on each sideboard 24 of the support seat 20 at an inner side. With the tabs 424 engaging in the locking hole 146 and the locking groove 148, one second tab washer 42 is fixedly disposed on each pivot flange 14 of the base seat 10 at an outer side. With the inserting tabs 504 engaging in the locking slots 144, one first irregular washer 50 is fixedly disposed on each pivot flange 14 of the base seat 10 at an inner side. The bolt shaft 306 of one pivotal shaft 30 passes through the engaging hole 242 of one sideboard 24, the deformed hole 412 of one first tab washer 41, the through hole 422 of one second tab washer 42, the center hole 502 of one first irregular washer 50, the latching hole 602 of one second irregular washer 60, two spring washers 71 and 72, and the irregular hole 802 of one flat washer 80. The nut 90 is screwed on the pivotal shaft 30 via the thread 308. The nut 90 is adjoining the flat washer 80. Thereby, a pivot mechanism is assembled. Another pivot mechanism is assembled in a similar manner. The support seat 20 is rotatable relative to the base seat 10. The second tab washers 42 and the first irregular washers 50 are non-rotatable relative to the base seat 10. The pivotal shafts 30, the first tab washers 41, the second irregular washers 60, the flat washers 80, and the nuts 90 are non-rotatable relative to the support seat 20.

In use, a pushing force is exerted on the display unit 100, and, in turn, the display unit 100 causes the base seat 10 to likewise move. The second tab washers 42 and the first irregular washers 50 rotate together with the base seat 10. When the display unit 100 rotates through a predetermined angle in one direction, one of the edges 1432 and 1434 resists one flat surface 310 to prevent the base seat 10 rotating further. The display unit 100 cannot rotate further accordingly. When the display unit 100 rotates in a reverse direction, another one of the edges 1432 and 1434 resists the above flat surface 310. The display unit 100 cannot rotate further likewise. In this process, the engagement of the side surfaces 506 and 606 of the first and second irregular washers 50 and 60, the spring washers 71 and 72 provide a variable axial force. Thus, a variable friction is generated and provides a variable moment. The moment can balance a rotational moment generated when the display unit 100 rotates. The first tab washers 41 and 42 are disposed between the base seat 10 and the support seat 20. This configuration may decrease the abrasion between the base seat 10 and the support seat 20 so as to prolong the use life.

In alternative embodiments, the pivotal shaft 30 is fastened, e.g., by means of other holding members such as a rivet or by a ring. In a similar manner, a C-shape ring and a receiving groove for example, may replace the nut 90 and thread 308 of the bolt shaft 306. The pivotal shaft 30 may also be fixed with the support seat by other ways, for example, be replaced with riveting or welding. Only single pivot mechanism may be provided. Accordingly, the pivot flange 14 and the sideboard 24 may also exist singularly. Other elastic members such as springs or other elastic washers may replace the spring washers 71, 72. The base seat 10 may be mounted to the support body 200, and accordingly the support seat 20 may be mounted to the display unit 100.

As described above, the preferred embodiments provides a hinge assembly 300 for devices such as a flat display screen, which is convenient for a user to operate and which is durable. It is, however, to be understood that the hinge assembly 300 could potentially be useful in other applications (e.g., a free-standing, adjustable mirror) in which it may be desirable to allow selective pivoting over a limited angular range.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a base seat, the base seat including a pivot flange, the pivot flange having a pivotal hole defined therein;
a support seat including a sideboard, the sideboard defining an engaging hole, the base seat being rotatable relative to the support seat;
a pivotal shaft, the pivotal shaft non-rotatably engaging in the engaging hole of the support seat;
two irregular washers each having a unsmooth side surface, one of the irregular washers non-rotatably connected to the base seat, another one of the irregular washers non-rotatably connected to the support seat, the side surfaces resisting each other for resulting in a variable moment when the irregular washers rotate relative to each other; two resilient washers disposed adjacent each other facing opposite directions for providing an axial force; and
a holding member disposed on the pivotal shaft;
wherein the pivotal shaft passes through the pivotal hole of the base seat, the engaging hole of the support seat, the irregular washers and the resilient washers, the holding member prevents the irregular washers, the resilient washers, the base seat and the support seat from being disengaged from the pivotal shaft.

2. The hinge assembly as claimed in claim 1, wherein the pivot flange of the base seat defines a protrusion therein, the protrusion is substantially V-shaped and has two symmetrical edges, the pivotal shaft has at least one flat surface for pivotally engaging with the edges of the protrusion for limiting a rotational angle between the base seat and support seat.

3. The hinge assembly as claimed in claim 1, wherein the hinge assembly further comprises two tab washers and a flat washer, the tab washers are disposed between the pivot flange and sideboard, the flat washer is disposed adjoining to the holding member.

4. The hinge assembly as claimed in claim 3, wherein the base seat comprises a main board, the pivot flange is perpendicularly extended from one end of the main board, the pivot flange defines two locking slots, a locking hole and a locking groove adjacent to each side of the pivotal hole, the locking groove is defined at a periphery of the pivot flange opposite to the main board, the locking hole is defined opposite to the locking groove, the support seat comprises a fixing board, the sideboard of the support seat defines two opposite fixing holes.

5. The hinge assembly as claimed in claim 4, wherein the tab washers each forms two opposite tabs at a periphery thereof, one of the irregular washers forms two inserting tabs at a periphery thereof, the tabs of one tab washer engage in the fixing holes of the support seat, the tabs of another tab washer engage in the locking hole and the locking groove of the base seat, the inserting tabs of the irregular washer engage in the locking slots of the base seat.

6. The hinge assembly as claimed in 5, wherein the pivotal shaft comprises a bolt cap, a middle portion and a bolt shaft, the flat surface is defined in the bolt shaft, the bolt shaft defines a thread on a distal end portion thereof opposite to the bolt cap, the holding member is a nut for engaging with the thread of the shaft portion.

7. The hinge assembly as claimed in claim 6, wherein the bolt cap is substantially a disk-like shape, the bolt cap is adjoining to the sideboard of the support seat.

8. The hinge assembly as claimed in claim 6, wherein the engaging hole of the support seat is “D” shaped, another irregular washer defines a “D” shaped latching hole, the flat washer defines an oval-shaped irregular hole, the bolt shaft of the pivotal shaft engages in the engaging hole, the latching hole and the irregular hole to ensure that the support seat, the irregular washer and the flat washer are non-roatable to the pivotal shaft.

9. The hinge assembly as claimed in claim 8, wherein one more pivot flange, one more sideboard, two more tab washers, two more irregular washers, two more resilient washers, one more flat washer, one more nut and one more pivotal shaft are provided.

10. The hinge assembly as claimed in claim 3, wherein the tab washers, the irregular washers, and the flat washer are ring-shaped, the resilient washers are plate-shaped.

11. A display monitor, comprising:
a support body;
a display unit; and
a hinge assembly configured for rotatably connecting the support body and the display unit, the hinge assembly comprising:
a base seat fixedly mounted to one of the support body and the display unit, the base seat including a pivot flange, the pivot flange having a pivotal hole defined therein;
a support seat fixedly mounted to another one of the support body and the display unit, the support seat including a sideboard, the sideboard defining an engaging hole, the base seat being rotatable relative to the support seat;
a pivotal shaft, the pivotal shaft non-rotatably engaging in the engaging hole of the support seat;
two irregular washers each having a unsmooth side surface, one of the irregular washers non-rotatably connected to the base seat, another one of the irregular washers non-rotatably connected to the support seat, the side surfaces resisting each other for resulting in a variable moment when the irregular washers rotate relative to each other;
two resilient washers disposed adjacent each other facing opposite directions for providing an axial force; and
a holding member disposed on the pivotal shaft;
wherein the pivotal shaft passes through the pivotal hole of the base seat, the engaging hole of the support seat, the irregular washers and the resilient washers, the holding member prevents the irregular washers, the resilient washers, the base seat and the support seat from disengaged from the pivotal shaft.

12. The display monitor as claimed in claim 11, wherein the pivot flange defining a protrusion therein, the protrusion is substantially V-shaped and has two symmetrical edges, the pivotal shaft has at least one flat surface for pivotally engaging with the protrusion.

13. The display monitor as claimed in claim 11, wherein the hinge assembly further comprises two tab washers and a flat washer, the tab washers are disposed between the pivot flange and sideboard, the flat washer is disposed adjoining to the holding member.

14. The display monitor as claimed in claim 13, wherein one of the tab washers and one of the irregular washers are non-rotatable relative to the base seat, the pivotal shafts, another tab washer, another irregular washer, the flat washer and the holding member are non-rotatable relative to the support seat.

15. The display monitor as claimed in claim 11, wherein the base seat comprises a main board defining at least one mounting hole, the base seat is mounted to one of the support body and the display unit by mean of the mounting hole, the support seat comprises a fixing board defining at least one assembling hole, the support seat is mounted to another of the support body by means of the assembling hole.

16. The display monitor as claimed in 11, wherein the pivotal shaft comprises a bolt cap, a middle portion and a bolt shaft, the flat surface is defined in the bolt shaft, the bolt shaft defines a thread on a distal end portion thereof opposite to the bolt cap, the holding member is a nut for engaging with the thread of the shaft portion.

17. The display monitor as claimed in claim 13, wherein the engaging hole of the support seat is “D” shaped, one irregular washer defines a “D” shaped latching hole, the flat washer defines an oval-shaped irregular hole, the bolt shaft of the pivotal shaft engages in the engaging hole.

18. A hinge assembly, comprising:
a pivotal mechanism comprising a pivotal shaft, the pivotal shaft having at least one flat surface;
a base seat defining a pivotal hole therein; and
a support seat defining an engaging hole, the base seat being rotatable relative to the support seat; and
wherein the pivotal shaft passes through the pivotal hole of the base seat and the engaging hole of the support seat, one of the base seat and the support seat defines a protrusion, the protrusion is substantially V-shaped and has two edges, the flat surface of the pivotal shaft pivotally engages with the protrusion, another one of the pivotal hole of the base seat and the engaging hole of the support seat non-rotatably engages with the pivotal shaft.

19. The hinge assembly as claimed in claim 18, wherein the pivotal mechanism further comprises two irregular washers each having a unsmooth side surface and two resilient washers disposed adjacent each other facing opposite directions, the unsmooth side surfaces of the irregular washers resisting each other.
